(19) United States
(12) Patent Application Publication
(10) Pub. No.: US 2012/0076485 A1
(43) Pub. Date: Mar. 29, 2012

(54) HIGH RESOLUTION PICTURE POLE

(76) Inventor: MICHAEL W. ZWAHR, Alvin, TX (US)

(21) Appl. No.: 12/890,905

(22) Filed: Sep. 27, 2010

(51) Int. Cl. G03B 17/00

(52) U.S. Cl. 396/425

(57) ABSTRACT

A picture pole system supports and protects a camera, typically a high resolution digital camera, at a height above the user. A cord may run from a trigger on a camera mounting frame along an extension pole to the user. The cord may permit the user, at one end of the pole, to take a picture with the camera, which is disposed at the other end of the pole. A focusing/stabilizing device may be attached to the pole near the camera. The focusing/stabilizing device may be placed against a subject to be photographed to provide a uniform focal length when taking pictures of multiple subjects, such as name plate data and/or manufacturer tag data in a chemical plant or refining industry.

### BACKGROUND OF THE INVENTION

The present invention relates to photography accessories and, more particularly, to a pole for extending the reach of a camera.

When information is needed about items stored on high shelves or storage bins, it may be difficult to see the items and/or identification information. For example, in a chemical plant or refining industry, collecting name plate data or manufacturer tag data often requires scaffolds or manlift operations. Typically, these operations require permitting, which may take up to two weeks to obtain. Often, the data being collected is moving and/or vibrating due to machinery being operated. Powering down of machines is often necessary to obtain data in these settings.

As can be seen, there is a need for an apparatus allowing a user to extend the reach of a camera to take a picture of remote data.

### SUMMARY OF THE INVENTION

In one aspect of the present invention, a picture pole system comprises a camera mount adapted to hold a camera; a trigger attached to the camera mount, the trigger adapted to depress a picture take button of the camera when depressed; a mounting bracket attaching the camera mount to a bracket post; and at least one post adapted to attach to the mounting bracket.

In another aspect of the present invention, a system for taking a picture at a distance from a user comprises a camera mount holding a camera; a trigger attached to the camera mount, the trigger adapted to depress a picture take button of the camera when depressed; a mounting bracket attaching the camera mount to a bracket post; at least one post extending from the mounting bracket; a cord operably attached to the trigger and disposed along the at least one post, the cord being pullable by a user; and a focusing/stabilizing device attached to the bracket post, the focusing/stabilizing device extending from the bracket post at about a 90 degree angle.

These and other features, aspects and advantages of the present invention will become better understood with reference to the following drawings, description and claims.

### BRIEF DESCRIPTION OF THE DRAWINGS

FIG. 1 is a perspective view of a picture pole system according to an embodiment of the present invention;

FIG. 2 is a front view of the picture pole system of FIG. 1;

FIG. 3 is a rear view of the picture pole system of FIG. 1;

FIG. 4 is a close-up perspective view of a trigger portion of the picture pole system of FIG. 1;

FIG. 5 is a front view of the trigger portion of FIG. 4; and

FIG. 6 is a side view of an adjustable length cord manager used in the picture pole system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a picture pole system that supports a camera, typically a high resolution digital camera, at a distance from the user. A cord may run from a trigger on a camera mounting frame along an extension pole to the user. The cord may permit the user, at one end of the pole, to take a picture with the camera, which is disposed at the other end of the pole. A focusing/stabilizing device may be attached to the pole near the camera. The focusing/stabilizing device may be placed against a subject to be photographed to provide a uniform focal length when taking pictures of multiple subjects, such as name plate data and/or manufacturer tag data in a chemical plant or refining industry.

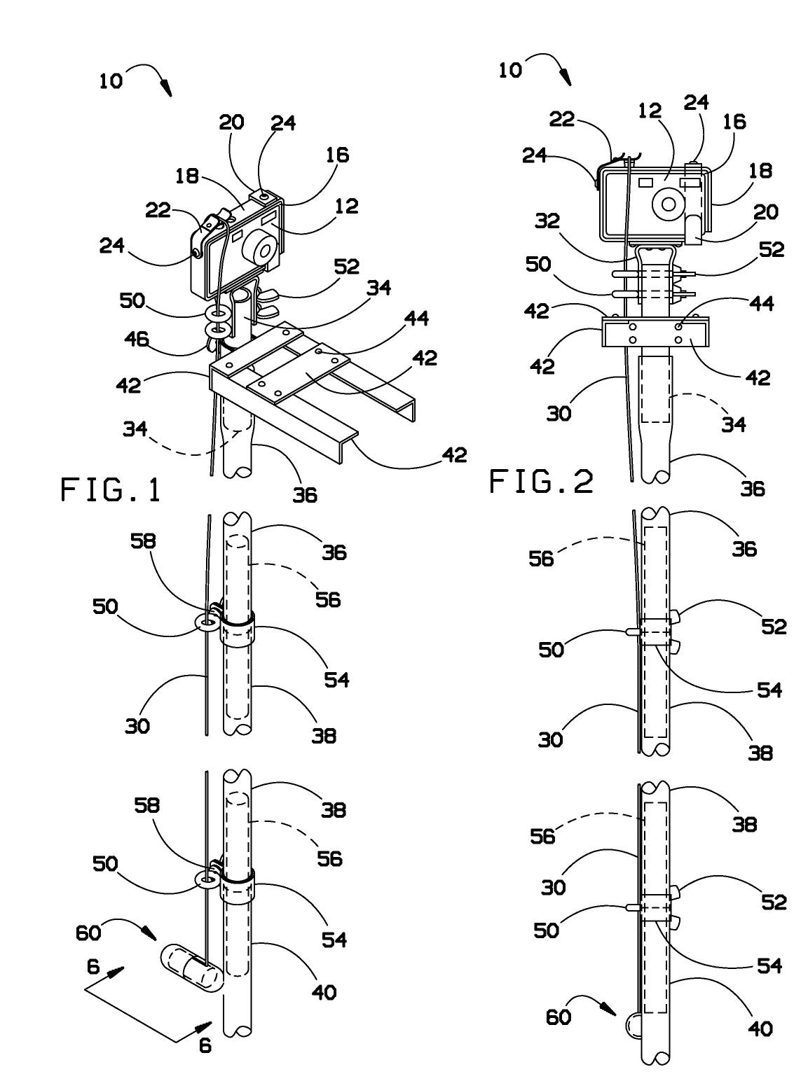

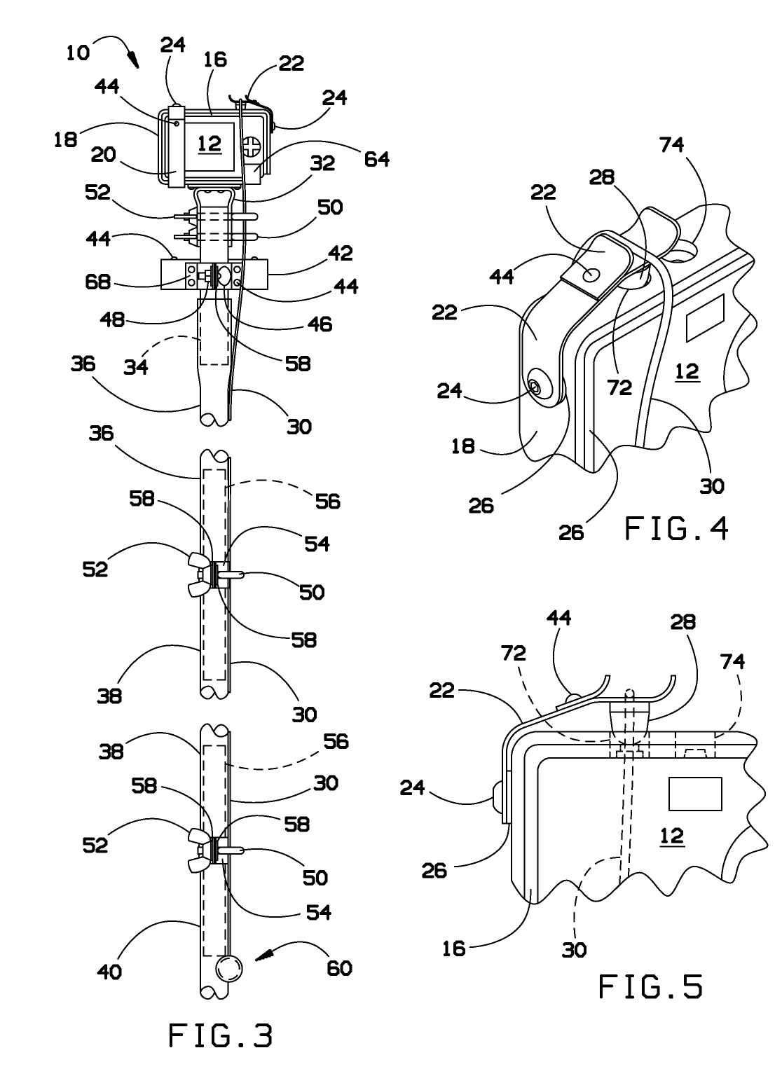

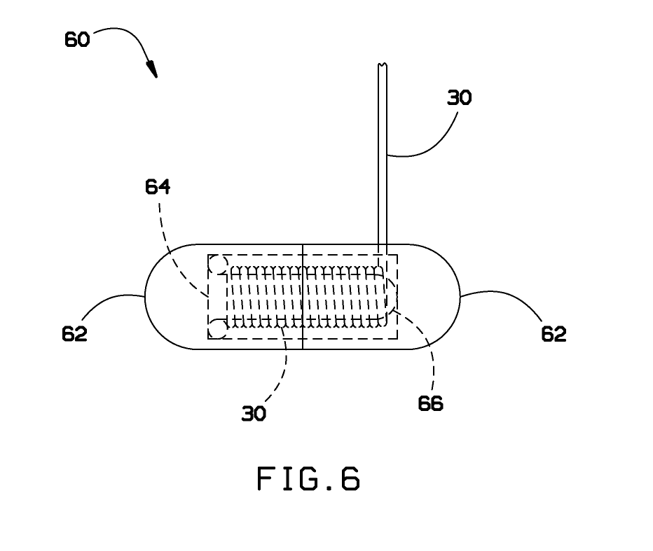

Referring to FIGS. 1 through 6, a picture pole system 10 may include a mounting frame 18 adapted to hold a camera 12. A picture take button access hole 72 and an on/off button access hole 74 may be formed through a portion of the mounting frame 18 to allow a user to turn the camera 12 on and off as well as for taking pictures. Memory foam 16 may be disposed around an inner periphery of the mounting frame 18 to support and cushion the camera 12 in the mounting frame 18. A retaining clip 20 may secure the camera 12 in the mounting frame 18. The retaining clip 20 may be held to the mounting frame 18 with a screw 24. The retaining clip 20 may encircle at least a portion of the camera 12 in the mounting frame 18, thereby containing the camera 12 securely in the mounting frame 18. The mounting frame 18 may be made from any suitable material, such as aluminum.

A trigger 22 may be attached to the mounting frame 18. The trigger 22 may be attached to the mounting frame 18 with a screw 24 and washer 26. The trigger 22 may be U-shaped, wherein the U-shape may secure a cord 30 against the top of the trigger 22 when pulled from below the camera 12. In some embodiments, the trigger 22 may be formed of two components, attached with a rivet 44. A variable stage actuator 28 may be disposed on the bottom of the trigger 22. The actuator 28 may align with the picture take button access hole 72. When a user pulls down on the cord, the trigger 22 may resilient bent, causing the actuator 28 to contact a picture take button (not shown) of the camera 12. The actuator 28 may be made of a soft material, such as memory foam, which helps the user to separately actuate each step (for example, a half-pressed button may focus the image and a fully-pressed button may take the picture) of pressing the picture take button.

A mounting frame bracket 32 may attach to the bottom of the mounting frame 18. The mounting frame bracket 32 may also attach to a bracket post 34 of the system 10. Eye bolts 50 and wing nuts 52 may be used to secure the bracket 32 to the bracket post 34. In some embodiments, the cord 30 may be fed through the eye bolts 50 to help guide the cord 30 to the user below the camera 12. The bracket post 24 may fit into an upper post 36. The upper post 36 may be connected to a middle post 38, and the middle post 38 may be connected to a lower post 40. In some embodiments, the posts 36, 38, 40 may each be about 5 feet in length. A supportive material, such as a wooden dowel 56, may be about 3 feet in length and may be disposed in the center of each post 36, 38, 40, resulting in about 1 foot of unsupported post at the ends of each post 36, 38, 40. An additional wooden dowel 56, having a length of about 2 feet, may be placed in this previously unsupported region, thereby providing support for the joint between the posts 36 and 38 or 38 and 40. A clamp, such as a rubber lined clamp 54 may be tightened at the joint between posts 36 and 38 and between posts 38 and 40. The clamp may include an eyebolt 50 and wingnut 52, similar to may be used to hold the mounting frame bracket 32 to the bracket post 34. In some embodiments, the posts 36, 38, 40 may be PVC pipe, typically ¾ inch Schedule 40 PCV pipe. The wooden dowels 56 may be, for example, ⅝ inch wooden dowels secured to the posts 36, 38, 40 with screws.

The system 10 may further include a focusing/stabilizing device 42 attached to the bracket post 34. When a user applies a slight force to the system 10, thus pressing the focusing/stabilizing device 42 to a surface, such as to a vibrating equipment surface, the camera may assume the exact or similar vibration pattern of the equipment, thereby eliminating or reducing the blur or double image that may result from photographing a vibrating subject. The focusing/stabilizing device 42 may be made, for example, of 1 inch aluminum angle that is fork-like in shape with two prongs attached with a ¾ inch U-bolt or a pipe clamp 68 to the bracket post 34. The focusing/stabilizing device 42 may set the distance from the target object and the size of the picture outline. This may permit a user to take consistent pictures at a uniform focal length. The focusing/stabilizing device 42 may be about 90 degrees square with the body of the camera and pointed in the same direction as the lens for a frontal shot, or set at any rotation angle as desired.

A cord manager 60 may attach to the lower post 40. The cord manager may store the cord 30 about a pipe 64 between two pipe caps 62. A wire clip 66 may be disposed inside the caps 62 for securing the cord 30. The cord 30 may be stored in the cord manager 60 when the system 10 is not in use, or when less than all of the posts are used.

While 5-foot posts 36, 38, 40 have been described, various lengths of posts may be used depending on the needs of the user. The 5-foot posts described above may be useful for disassembly and ease of carrying throughout a factory, for example. Therefore the system 10 may be stored and easily deployed when needed. The system 10 of the present invention may be useful not only in a manufacturing setting, but also to inspect roofs for roofing inspectors or insurance adjustors, to inspect at or near the waterline of ships, to take pictures of wildlife at a safe distance, or the like.

To take a picture, a user may assemble the system 10 and tie a loop in the cord 30. The loop may be placed around the camera mount and in the U-shaped trigger. The cord 30 may run through the eye bolts to the user. The focusing/stabilizing device 42 may rest on the object and the cord may be pulled. A ½ inch, slow, 1-second tub on the cord may actuate both states of the picture take button.

It should be understood, of course, that the foregoing relates to exemplary embodiments of the invention and that modifications may be made without departing from the spirit and scope of the invention as set forth in the following claims.

What is claimed is:

1. A picture pole system comprising:
a camera mount adapted to hold and protect a camera;
a trigger attached to the camera mount, the trigger adapted to actuate an autofocus and depress a picture take button of the camera when operated;
a mounting bracket attaching the camera mount to a bracket post; and
at least one post adapted to attach to the mounting bracket.

2. The picture pole system of claim 1, further comprising a focusing/stabilizing device attached to the bracket post, the focusing/stabilizing device extending from the bracket post at about a 90 degree angle.

3. The picture pole system of claim 1, further comprising three posts adapted to be interconnected, thereby extending a reach of the camera mount from a user.

4. The picture pole system of claim 3, further comprising a first supporting material disposed in a central region of each post, wherein about a 1 foot section of each post, on each end thereof, is without the first supporting material.

5. The picture pole system of claim 4, further comprising a second supporting material fitting on abutting ends of two adjacent posts.

6. The picture pole system of claim 5, wherein the supporting material is a wooden dowel.

7. The picture pole system of claim 1, further comprising a cord operably connected to the trigger, the cord adapted to be pulled by a user, actuating the trigger, and causing the camera to take a picture.

8. The picture pole system of claim 7, further comprising a cord manager for storing at least a portion of the cord when not in use.

9. A system for taking a picture at a distance from a user, the system comprising:
a camera mount holding a camera;
a trigger attached to the camera mount, the trigger adapted to depress a picture take button of the camera when depressed;
a mounting bracket attaching the camera mount to a bracket post;
at least one post extending from the mounting bracket;
a cord operably attached to the trigger and disposed along the at least one post, the cord being pullable by a user; and
a focusing/stabilizing device attached to the bracket post, the focusing/stabilizing device extending from the bracket post at about a 90 degree angle.

10. The system of claim 9, wherein the focusing/stabilizing device extends a predetermined focal length from the bracket post.
